(19) United States
(12) Patent Application Publication
(10) Pub. No.: US 2002/0071513 A1
(43) Pub. Date: Jun. 13, 2002

(54) Miniature endoscope and method for the inspection of fuel elements

(76) Inventor: Jurgen Uckert, Marloffstein (DE)

Correspondence Address: LERNER AND GREENBERG, P.A., Post Office Box 2480, Hollywood, FL, 33022-2480, US

(21) Appl. No.: 09/929,173

(22) Filed: Aug. 13, 2001

Related U.S. Application Data
(63) Continuation of application No. PCT/DE00/00373, filed on Feb. 8, 2000.

(30) Foreign Application Priority Data
Feb. 12, 1999 (DE) 199 05 970 .5

(51) Int. Cl. G21C 17/00

(52) U.S. Cl. 376/248

(57) ABSTRACT

A device and a method for inspecting fuel elements of a nuclear reactor underwater are described. A remote controlled miniature endoscope forming part of an inspection device is introduced into the fuel element and the non-easily accessible parts of the fuel element located therein are inspected without having to disassemble the fuel element.

### CROSS-REFERENCE TO RELATED APPLICATION

This application is a continuation of copending International Application PCT/DE00/00373, filed Feb. 8, 2000, which designated the United States.

### BACKGROUND OF THE INVENTION

### FIELD OF THE INVENTION

The invention relates to an apparatus for the inspection of a fuel element in a nuclear reactor. The apparatus has an endoscope, which is connected to an electronic image-receiving device, to a light source and to an actuating device, and is remotely controlled. The invention further relates to the use of the endoscope and a method using the endoscope for the inspection of a fuel element disposed under water in a nuclear reactor. For example, the surface of a fuel rod or of a barely accessible region of a bottom piece or a spacer can be inspected.

In order to inspect the fuel element in the nuclear reactor, the fuel element is generally looked at closely and inspected visually. The visual inspection can be carried out before the first use of a fuel element in a nuclear reactor, after a use cycle or when the fuel element is being replaced. Because of the breakdown of the nucleides present in the fuel, radioactive radiation emerges from the fuel element. The visual inspection of fuel elements is therefore generally carried out under water in a basin belonging to a nuclear power station, mostly at a water depth of more than 10 m, to some extent down to 30 m.

During the final acceptance in the fuel element production or during the quality testing of the fuel elements after they have been delivered to the nuclear reactor, an inspection can also be carried out in a test room and not under water. In principle, an apparatus for the inspection of the fuel elements in a nuclear reactor can also be used for these purposes.

In addition to the inspection of the outer surfaces, in particular a visual inspection of internal regions is also advantageous.

An apparatus for a boroscope—that is to say a pipeline system in which images are transmitted via mirrors—is described in U.S. Pat. No. 4,036,686. The boroscope can, for example, be introduced into the fuel element passages in a fuel element and can transmit images from the interior of a fuel element. However, it is not flexible and is too bulky to inspect any desired (in particular barely accessible) regions of the fuel element, for example of a bottom piece or of a spacer.

U.S. Pat. No. 4,229,069 proposes an endoscope for use in ionizing radiation fields, in particular for observing highly radioactive material. However, it cannot be controlled remotely and is therefore not suitable for the inspection of a fuel element. However, measures are indicated here to make the endoscope particularly resistant to radioactive radiation. These include, for example, an advantageous composition of the glass fiber material. In addition, a heating apparatus for the temperature stabilization of part of the endoscope facing the fuel element is proposed. In addition, the endoscope is intended to be located in a fixed tube or a flexible metal housing in order to protect it against radioactive radiation.

An endoscope according to U.S. Pat. No. 5,152,957 is part of a cleaning device for finding and eliminating foreign bodies, in particular in fuel element passages. It is rigid and conducts produced images of the foreign bodies and of a cleaning device via a long glass fiber to a camera above the water level. The endoscope is therefore not suitable for the inspection of all regions of a fuel element, in particular barely accessible regions. In addition, it is impossible to avoid severe damage to the glass fiber from radioactive radiation, under which the inspection of the fuel elements suffers. The glass fiber is too long and is guided along the entire length of the fuel element to be inspected. The fiber is therefore exposed to radiochemical breakdown arising from ionizing radiation over a large part of its length. This leads to a weakening of the image, which loses its brightness during its long propagation path through the fiber.

### SUMMARY OF THE INVENTION

It is accordingly an object of the invention to provide a miniature endoscope and a method for the inspection of fuel elements which overcome the above-mentioned disadvantages of the prior art devices and methods of this general type, which make it possible to inspect even internal, in particular barely accessible, regions of a fuel element, even under severe radioactive radiation.

With the foregoing and other objects in view there is provided, in accordance with the invention, an apparatus for inspecting a region of a fuel element including a spacer and a bottom piece in a nuclear reactor. The apparatus contains an image production device having an electronic image receiving device; an endoscope having an intrinsically flexible end piece with an endoscope objective carried by the intrinsically flexible end piece; a light guide for images optically connecting the endoscope objective to the electronic image receiving device; an actuating device having an actuating motor for bending at least the intrinsically flexible end piece; and an illumination device having a light source sending light to be discharged from the intrinsically flexible end piece.

The object is achieved by the apparatus for the inspection of a region of the fuel element in the nuclear reactor, in particular for the inspection of the surface of a fuel rod or of a barely accessible region of a bottom piece or of a spacer. In a first variant of the invention, the endoscope is provided, in particular a miniature endoscope, having an end piece that carries the endoscope objective and is interchangeable. In a watertight container, at least one electronic image-receiving device is connected to an image production device, to a light source and to an actuating motor of an actuating device disposed at another end of the endoscope. In addition, the components are disposed in the container so as to be protected against radioactive radiation.

In the first variant, the invention is based on the finding that the endoscope can substantially not be adequately protected against radioactive radiation during visual inspection in the immediate vicinity of the fuel element.

Although measures may be taken to increase the radiation resistance, as have already been described in principle in U.S. Pat. No. 4,229,069, the destruction of the endoscope by the radioactive radiation is unavoidable. At least that part of the endoscope which is mostly stressed, that is to say that part which projects into the fuel element, namely the end piece of the endoscope, is therefore interchangeable. The interchangeable part is preferably to be interchangeable simply and rapidly and can be replaced cheaply. Conventional endoscopes permit, for example, an adequately long net usable time for inspection with high quality of at least one hour in the immediate vicinity of the fuel element.

Furthermore, according to the invention the endoscope is kept as short as just possible and is predominantly disposed at right angles to the fuel element. The radiochemical destruction of the endoscope, such as occurs to an enhanced extent when the endoscope is guided along the entire length of the fuel element as far as an eyepiece above a water surface, as described in U.S. Pat. No. 5,152,957, is therefore suppressed to the greatest possible extent.

According to the invention, therefore, the container with the devices disposed in it, together with the endoscope, is led up to the fuel element for the purpose of inspection. While the endoscope is easy to replace after excessively long action of radiation, the aforementioned devices in the watertight container are protected against radioactive radiation and therefore do not need to be replaced regularly.

In an advantageous development of the aforementioned first variant of the invention, an illumination device is provided which radiates light from a light source from an objective-side end of the endoscope. This has the advantage that, for the visual inspection of a region of the fuel element, the interesting region can be illuminated directly in a field of view of the endoscope. As compared with indirect illumination, for example by a lamp which radiates its light in from a direction that differs from that in the direction of view of the endoscope, shadowing is avoided in the case of this solution according to the invention, and therefore the quality of the visual inspection is improved.

In particular, a development of the apparatus according to the invention contains an actuating device, which is provided at least to move and/or to rotate at least the end piece of the endoscope. This is because, in the aforementioned first embodiment of the invention, the use of a rigid endoscope is not ruled out. The movement, for example by tilting or pivoting at least the end piece of the endoscope by the aforementioned actuating device, therefore enlarges the viewing angle of the endoscope which can be achieved, and therefore the region of a fuel element inspected by the apparatus, even if the endoscope is rigid. Likewise, the rotation at least of the end piece of the endoscope has the effect of enlarging the viewing angle range, if the preferably rigid endoscope is equipped with a prism at the objective end.

The aforementioned first variant of the invention is particularly advantageously equipped with an end piece, which is intrinsically flexible. In particular, an apparatus with an endoscope at least having a flexible end piece is provided for the inspection of a barely accessible region of a fuel element, for example of a bottom piece or of a spacer, since the endoscope may be bent in particular into spacer holding cells or grid cells of the bottom piece. The inspection can therefore be carried out without the fuel element having to be opened. In this case, depending on the requirement, a rigid endoscope can be interchanged for an endoscope in which at least the end piece is flexible.

According to a second variant of the invention, this results in an apparatus which has an endoscope with an intrinsically flexible end piece carrying an endoscope objective, an actuating device, which is provided to bend at least the end piece, an illumination device, which is provided to discharge light from the end piece, and an image production device at another end.

In the case of the second variant, the invention is based on the finding that when the endoscope, in particular a rigid endoscope, is inserted into the fuel element, both the fuel element and the endoscope can be damaged. This hazard can result from the accidental striking or canting of the endoscope in the fuel element, if relatively high mechanical forces act on both. This is sometimes virtually unavoidable. This is because the use of the endoscope frequently requires the endoscope to be adjusted accurately at a distance of 10 to 30 m or more with an accuracy of 2 to 3 mm. On the other hand, an intrinsically flexible endoscope can be inserted into the fuel element in a less susceptible manner and virtually adjusts itself as it is inserted, by deforming in accordance with the situation, for example during insertion into a fuel element passage. For this purpose, a flexible, for example metallic, tube, which is flexible up to a certain degree is advantageously used. The stiffness of such a tube is, for example, sufficient to carry the dead weight of the endoscope, so that the tube remains in its current form after being bent. The tube does not need to be protected to any noticeable extent against the radioactive radiation and can therefore be configured to be as flexible as necessary. Otherwise, the endoscope can be constructed like a medical endoscope. However, it is advantageous for the material used for the fiber bundle of such a known endoscope, which is as insensitive as possible to radioactive radiation. Such materials, such as glasses, are described in U.S. Pat. No. 4,229,069.

The second variant of the invention further makes use of the fact that the bending of an intrinsically flexible endoscope can be controlled by an actuating device. With the aid of the actuating device to bend at least the end piece of the endoscope, it is possible, as already explained, for the achievable viewing angle of the endoscope to be enlarged substantially, in particular for the inspection of barely accessible regions of a fuel element. By bending the endoscope into niches or corners of the fuel element, even subregions of the fuel element, which cannot be reached with a rigid endoscope can also be moved into the field of view.

Finally, a variant of the invention contains an illumination device, which is provided to discharge light from the end piece and therefore, for example by avoiding shadowing, is suitable for improving the inspection quality. An image production device at another end of the endoscope is used to record the image produced by the endoscope. This variant is primarily used in order also to track down foreign bodies, which have been caught at the bottom, in a spacer or between the fuel rods.

The apparatus according to the invention advantageously provides an end piece, which is intrinsically flexible over a length of at least 10 mm, preferably about 50 mm. In particular, it is beneficial if the end piece is suitable to be bent with a radius of curvature greater than 10 mm. Furthermore, it is advantageous if the end piece is flexible in two directions, preferably on all sides. The flexible length of the end piece, the radius of curvature of the end piece and the directions of bending are, according to the invention, to be adapted to the requirements of the situation during the inspection, are made possible by choosing various interchangeable endoscopes.

The aforementioned actuating device is preferably embodied, at least to bend the end piece of the endoscope, by a mechanical pulling device fixed to the endoscope objective. The mechanical pulling device may contain, for example, two pull cords or up to four pull cords. In order to operate the pulling device, use is made of at least one actuating motor. The latter is advantageously operated under remote control, for example via a control device, as described later. A further embodiment of the actuating device contains, for example, a rigid construction and an actuating motor for rotating the rigid construction together with the endoscope objective. The latter embodiment of the actuating device is fitted in particular in a rigid endoscope, preferably in the case of an endoscope with an endoscope objective or a prism at the front end of the end piece of the endoscope.

A further embodiment of the invention contains a rigid part for guiding a center portion of the endoscope, so that the latter is expediently stabilized. To this end, a fixed ring or a guide rail, for example, is provided to support the endoscope. However, a preferably metallic hose, for example a corrugated hose, can also be provided, which is not completely rigid but may be bent and then remains in the bent form. This is provided in particular in the case of the endoscope that is flexible over its entire length. The further configuration of the apparatus according to the invention contains an electronic camera in the image production device to record an image supplied by the endoscope. This may be, for example, a black/white or a color camera. The camera is advantageous robust and of a low-noise configuration. A Vidicon camera, a CCD camera, or a CMOS camera are suitable. Also advantageous is any type of camera with at least 400 lines image resolution.

Furthermore, the apparatus according to the invention preferably provides a front optical opening at the objective end of the endoscope. The opening is also used to discharge light from the end piece. The light is supplied by a light source belonging to an illumination device of the apparatus according to the invention. The illumination device and the image production device preferably contain at least one light guide, preferably at least one bundle of individual fibers. Furthermore, according to the invention it is beneficial for separate light guides to be provided for the transmission of images and light. Thus, for the transmission of images and light to achieve the object according to the invention, preferably at least one bundle of individual fibers is provided. These image and light conductors advantageously contain up to 10,000 individual quartz fibers. According to the invention, the illumination device is configured to discharge virtually white light, preferably light similar to daylight. This is implemented, for example, by a suitable selection of a gas pressure lamp, for example a xenon lamp, whose spectrum can be characterized by a temperature in the range from about 5,000 to 7,000 Kelvin. The power of the lamp should be about 100 W.

The apparatus is preferably characterized by a flange for interchanging at least the end piece of the endoscope. The flange is advantageously also provided for coupling the endoscope to the image production device, to the illumination device and to at least one actuating motor. According to the invention, it is advantageous if the endoscope, the image production device and the illumination device and the actuating device are resistant to radioactive radiation. In particular, the endoscope is watertight. Furthermore, according to the invention it is beneficial if the image receiving device and/or the illumination device are protected against radioactive radiation by a shield. According to the invention, a container and a shield advantageously provide protection against radioactive radiation, at least up to a distance of 0.5 m from the fuel element. In addition to the endoscope, the image production device, the actuating device and the illumination device are also watertight. According to the invention, it is advantageous if the electrical parts of the image production device, of the actuating device and of the illumination device are protected against water, in particular at a water depth of more than 10 m, advantageously at least down to a water depth of 30 m. In this way, all the relevant components are additionally advantageously resistant or protected at a distance of about 0.5 m from the fuel element against a radioactive radiation power of about 10⁸ to 10¹⁰ mrad/h.

For this purpose, low-noise components, for example relating to the image receiving device and illumination device, are used. In addition, radio-chemically resistant materials relating to the endoscope are used, for example cerium doped lenses in the endoscope objective and/or endoscope eyepiece.

For example, lead plates or a radiation-proof box offer adequate protection. Here, it is preferable if fewer radiation-sensitive parts (for example the light source) are disposed relatively close to the fuel element, in order to create space for the camera or other sensitive parts, for which a greater distance is beneficial in the sense of shielding the beam.

The flange is of a watertight configuration, at least for a water depth of more than 10 m, advantageously at least up to 30 m. In addition, for sufficiently good operation of the apparatus, heat dissipation from the watertight housing as a result of the discharge of heat from the gas pressure lamp is necessary.

The apparatus preferably contains a mounting frame, which carries at least the image production device, the actuating device and the illumination device. The mounting frame is expediently fixed to a position manipulator, which is remotely controlled, for example from the rim of a fuel element storage basin in a nuclear reactor. In this way, therefore, all the devices needed directly for the operation of the endoscope, together with the endoscope, are led up to the fuel element, and are therefore under water during the inspection. An image recording device and/or an image display device are/is preferably also provided to record and/or to reproduce the images produced by the image production device. These are in particular disposed above the water surface. The devices are then viewed by the observer who is inspecting the fuel element, and the images of the subregions of a fuel element are, for example, displayed on a monitor or recorded, for example on a video cassette.

Accordingly, the apparatus according to a development of the invention also contains a control device for the remote control of the endoscope. Likewise, the apparatus can contain an electrical power supply device, which is provided to feed a light source, an image production device and at least one actuating motor. The aforementioned control device and the aforementioned power supply device are preferably likewise disposed above the water surface and can be operated by the observer. It is advantageous if only one electrical line or one control line, which are virtually not susceptible to radioactive radiation, are led along the fuel element, underneath the water, to the aforementioned container.

It is part of the invention to use an intrinsically flexible endoscope for the surface inspection of the region of the fuel element disposed under water in a nuclear reactor, in particular in conjunction with a camera disposed under water. As already explained, the use of intrinsically flexible endoscopes permits an enlargement of the inspectable region of a fuel element and an enhancement of the inspection quality. The comparatively inexpensive interchangeability of at least one endoscope end piece circumvents the increasing radiochemical breakdown of the endoscope material. This necessarily occurs, even in the case of endoscope materials that are protected in a complicated manner, such as those according to U.S. Pat. No. 4,036,686.

Furthermore, the invention specifies a method for the inspection of a region of a fuel element disposed under water in a nuclear reactor, for example for the inspection of a surface of a fuel rod or of a barely accessible region of a bottom piece or of a spacer. According to the invention, the endoscope with the intrinsically flexible end piece carrying the endoscope objective, together with the actuating device, the illumination device and the image production device is brought up to the fuel element under water. In a further step, the end piece is led up to a subregion of the fuel element in such a way that the subregion comes into the field of view of the endoscope. The field of view of the endoscope is preferably determined by a depth of focus of about 1 to 3 cm and an objective aperture of up to 60°. In addition, the field of view of the endoscope can be expanded or set flexibly, for example by a zoom objective. A further device for changing the field of view is an interchangeable optical system, which is placed between a light guide and an image production device (“coupler”). This relates, for example, to a flexibly interchangeable eyepiece of the endoscope. Then, the aforementioned subregion and further subregions of the fuel element are inspected. According to the invention, these are those, which come alternately into the field of view of the endoscope as a result of displacement of the endoscope and/or as a result of curvature of the end piece, it being possible for the field of view to be illuminated by the illumination device. In this way, virtually all regions of a fuel element are accessible to visual inspection.

Other features which are considered as characteristic for the invention are set forth in the appended claims.

Although the invention is illustrated and described herein as embodied in a miniature endoscope and a method for the inspection of fuel elements, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic illustration of an apparatus for inspecting a fuel element, which is brought up to a fuel element by a position manipulator according to the invention;

FIG. 2 is an exploded, perspective view of an intrinsically flexible endoscope brought up to a barely accessible region of a bottom piece;

FIG. 3 is an illustration of an intrinsically flexible, interchangeable endoscope with a watertight container, which is protected against radioactive radiation;

FIG. 4 is a sectional view of an interchangeable, rigid end piece of the endoscope;

FIG. 5 is a perspective view of the interchangeable, intrinsically flexible end piece of the endoscope;

FIG. 6 is a front-elevational, partially broken away, view of the endoscope having an image production device and an illumination device;

FIG. 7 is a perspective view of a method for inspecting the surface of a fuel rod;

FIG. 8 is a perspective view of a method for inspecting a barely accessible region of a bottom piece.

### DESCRIPTION OF THE PREFERRED EMBODIMENTS

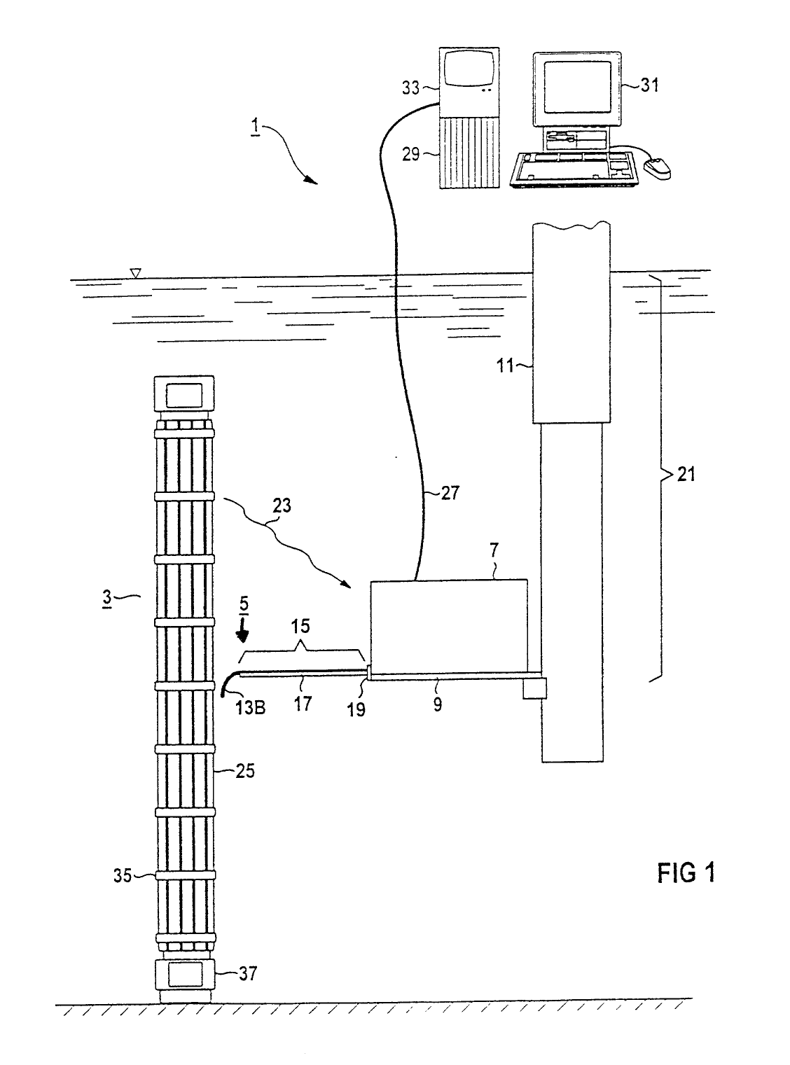

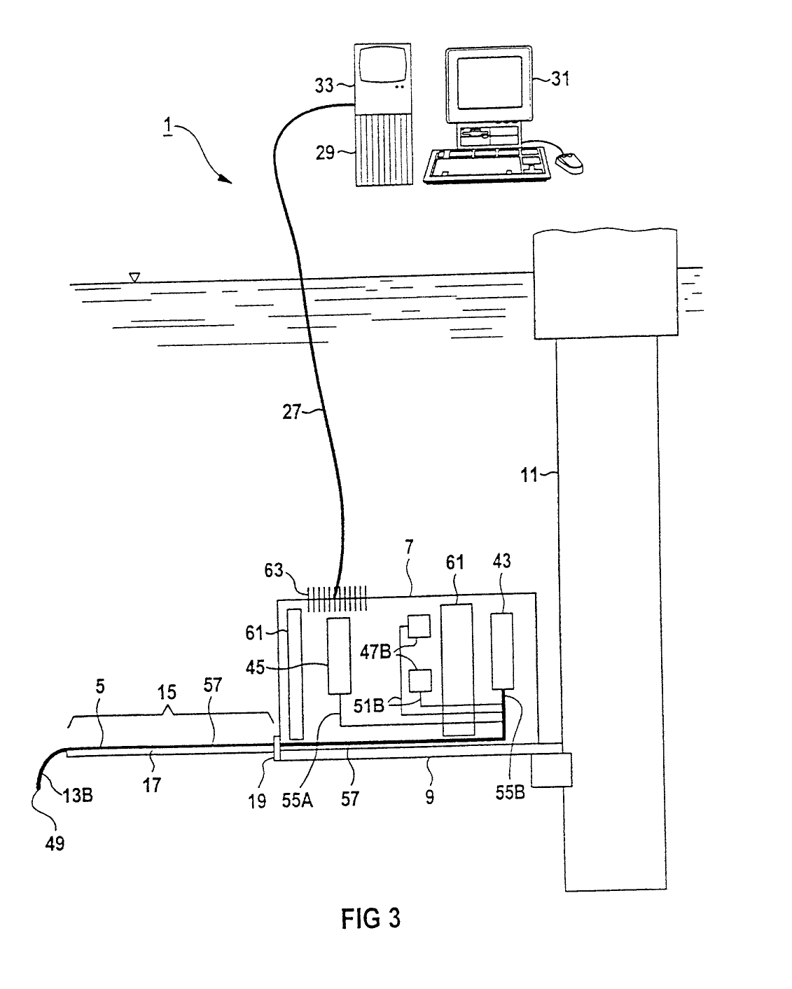

In all the figures of the drawing, sub-features and integral parts that correspond to one another bear the same reference symbol in each case. Referring now to the figures of the drawing in detail and first, particularly, to FIG. 1 thereof, there is shown the construction of an apparatus 1 for inspecting a fuel element 3. The inspection apparatus 1 substantially contains an endoscope 5 and a watertight, radiation-protected container 7, which are carried by a mounting frame 9. The mounting frame 9 is fixed to a position manipulator 11, which is provided to move the endoscope 5 and the watertight container 7 up to the fuel element 3. In this embodiment, the endoscope 5 has an intrinsically flexible end piece 13B which is held in a center part 15 by a rigid part 17, in this case a guide rail 17. The endoscope 5 is coupled to the container 7 in a watertight manner via a flange 19. The flange 19 is used to interchange the endoscope 5 and to couple it to devices accommodated in the watertight container 7, which are described in more detail in FIG. 3.

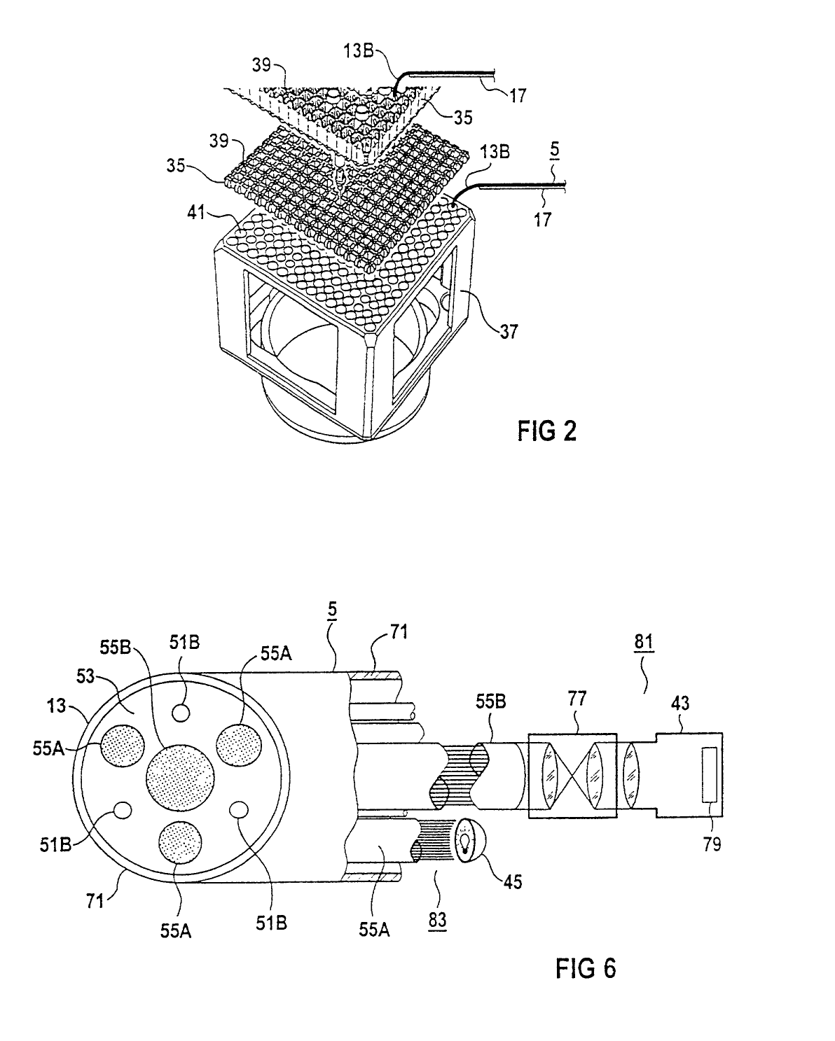

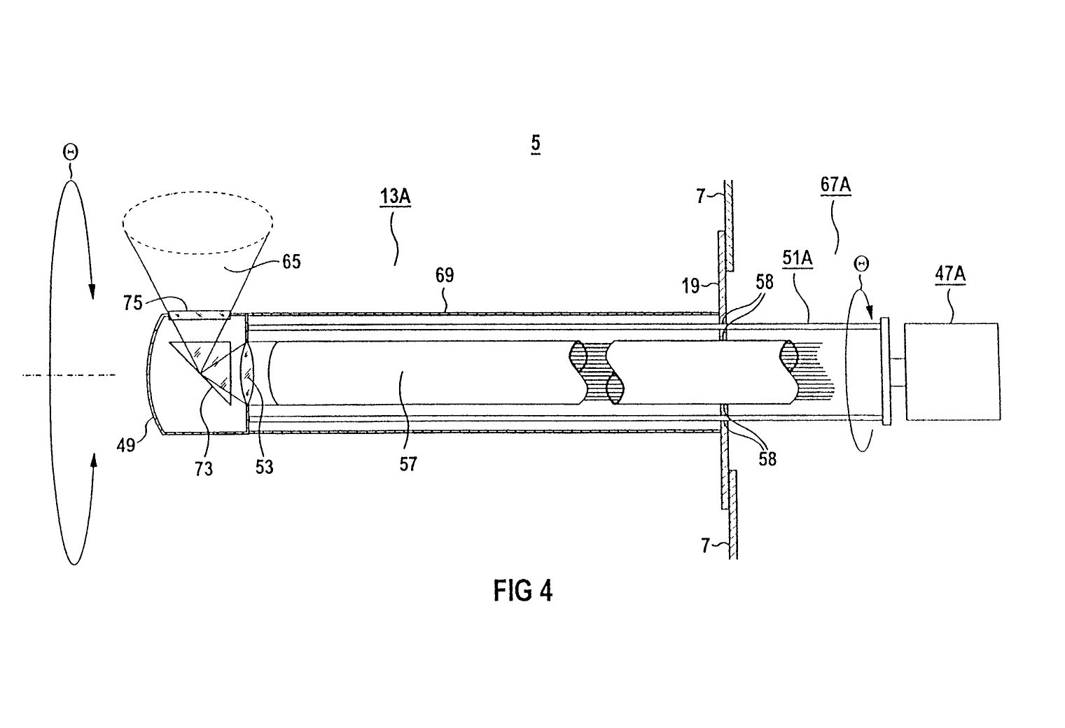

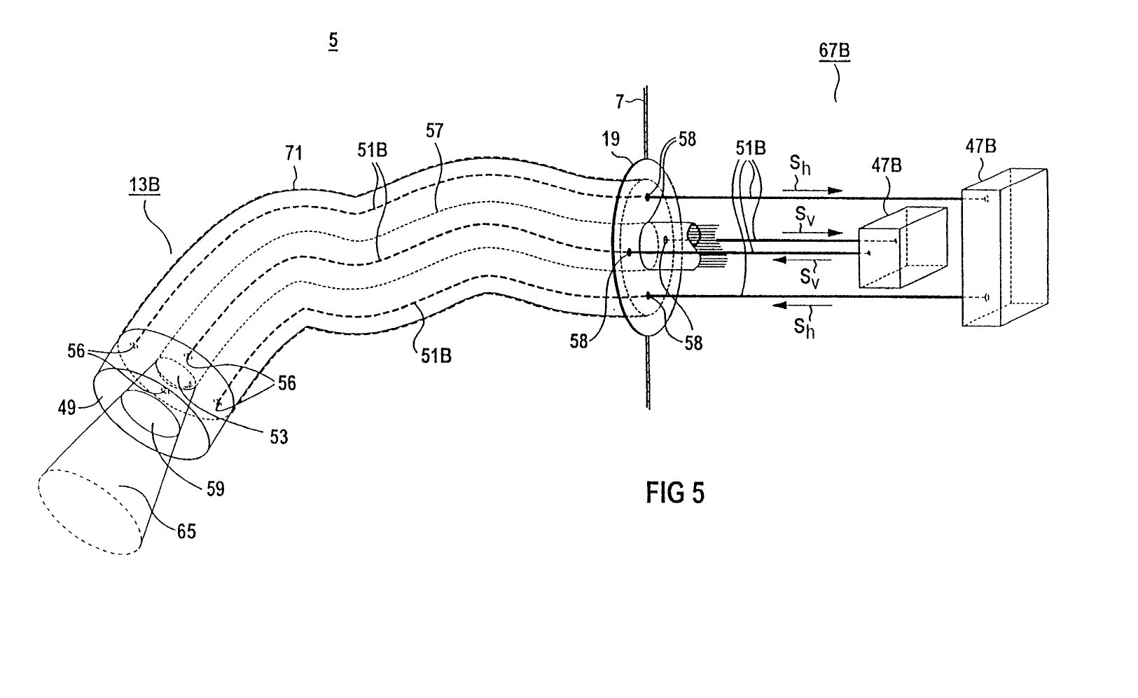

For the purpose of inspection, the endoscope 5, together with the watertight container 7, is provided to be brought up to the fuel element 3 down to a water depth 21 via the manipulator 11. All the necessary parts are accordingly protected against water and radioactive radiation 23. The parts are at least an image receiving device 43, an illumination device 45 (FIG. 3) and at least one actuating motor 47A, 47B (FIGS. 4, 5). The inspection apparatus 1 is therefore provided for the inspection of a region of the fuel element 3, in particular a surface of a fuel rod 25, or of another region of the fuel element 3, for example a barely accessible region, as shown in FIG. 2.

A line 27 for controlling the endoscope 5 and the electrical power supply to the devices in the container 7 advantageously forms, in this embodiment, the single connection to a power supply device 29 and to a control device 31 (FIG. 1). The latter are disposed, for example, at the rim of a fuel element storage basin of a nuclear reactor. Also advantageously disposed there is an image recording device and image display device 33, so that the remote control of the endoscope 5 and the visual inspection of the same by service personnel can be performed from there.

FIG. 2 shows two exemplary procedures for the inspection of barely accessible regions of the fuel element 3, for example of a spacer 35 or of a bottom piece 37. The inspection, for example, of a spacer cell 39 or a cell 47 of the bottom piece 37 is performed by the intrinsically flexible end piece 13B of the endoscope 5 being bent into the corresponding cell 39 or 41. Thus, for example, corroded surfaces can be made out or foreign parts can be found even in these barely accessible regions.

FIG. 3 shows the endoscope 5 and the watertight, radiation-proof container 7 and also the devices accommodated in the container 7 in detail. It is again possible to see the lower part of the position manipulator 11 and of the mounting frame 9 which is fitted thereto and which carries the container 7 and the endoscope 5. It is also possible to see, as in FIG. 1, the line 27 for control and the electrical power supply, which leads upward to the control and power supply devices 31, 33, 29 above the water surface.

In this embodiment, the endoscope 5 again has an intrinsically flexible end piece 13B and in its center portion 15 is supported by the rigid part 17. Furthermore, in this configuration, the endoscope 5 is coupled to the housing 7 via the flange 19 in order to interchange the endoscope 5. The flange 19 is watertight, as is the container 7, at least down to a depth of 10 m, advantageously down to at least 30 m. The flange 19 is also used to couple the endoscope 5 to the light source 45, to the electronic image-receiving device 43, an electronic camera 43 in this case, and to two actuating motors 47B.

The actuating motors 47B are provided to bend the intrinsically flexible end piece 13B of the endoscope 5 via a mechanical pulling device 51B. For this purpose, the mechanical pulling device 51B is connected to an endoscope objective 53 (FIGS. 4, 5) at a front end 49 of the end piece 13B of the endoscope 5 and is actuated via the actuating motors 47B. A light guide 55A for light leads away from the light source 45. Together with a light guide 55B for images, which opens into the electronic image receiving device 43, the two light guides 55A and 55B are led as a bundle of individual fibers 57 as far as the endoscope objective 53 (FIGS. 4, 5). In this way, the images supplied by the endoscope 5 are led to the electronic camera 43 and, the light discharged by the light source 45 is led to a front optical opening 59 (FIG. 5) at the front end 49 of the end piece 13B of the endoscope 5.

In addition to the container 7, further protective apparatus or shields 61 (FIG. 3) within the container 7 are used to shield against radioactive radiation 23, to protect at least the light source 45 and the electronic camera 43. A lead plate, for example, can be used as the shield 61. Furthermore, the devices are disposed within the container in such a way that the most sensitive parts, the electronic camera 43 in this case, are located at the greatest distance from the radiation source, that is to say the fuel element 3.

As already mentioned, use is made here of, for example, of a xenon gas pressure lamp as the light source 43, with a spectrum which is characterized by a temperature of about 6,000 Kelvin, that is to say similar to daylight. The transparent window belonging to the optical conductors 55A, 55B, 57 used to transmit the light from the light source 45 and the images to the camera 43 must accordingly be of a broadband configuration. Furthermore, cooling ribs 63 are preferably fitted to the housing 7, at least in the vicinity of the light source 45, and are used for better heat dissipation of the heat power produced by the light source 45. According to the configuration in FIG. 3, the guide rail 17 supports not only the center portion 15 of the endoscope 5 but, advantageously, also the fiber bundle 57, continued in the housing, for the transmission of images and light.

FIG. 4 shows, by way of example, an advantageous embodiment of an end piece 13A of the endoscope 5 having an advantageous embodiment of an actuating device 67A. The endoscope 5 with the end piece 13A is enclosed by a rigid tube 69, which is produced, for example, from metal or PVC material. In the embodiment shown in FIG. 4, the endoscope 5 is closed at the front end 49, but for this purpose contains a lateral optical opening 75. Through the lateral optical opening 75, light for illuminating a field of view 65 is intended to emerge, and through the opening 75, the image produced by the endoscope 5 of a partial view, for example of the fuel element 3, is intended to be picked up. Within the tube 69, the bundle of individual optical fibers 57 is used for the transmission of both images and light. In this embodiment, use is further made of a lens 53 and a prism 73 as the endoscope objective. The lateral optical opening 75 functions as an objective aperture. If required, instead of the objective there may also be, for example, a zoom objective, in order to adjust the optical properties, such as depth of focus or enlargement of the endoscope 5, in a variable manner. At another end of the endoscope 5 there is located the flange 19, to be coupled to the watertight housing 7. The flange 19 in FIG. 4 bears schematically illustrated lead throughs 58 for coupling the glass fiber bundle 57, a mechanical pulling device 51A inside and outside the watertight, radiation-proof housing 7. In the embodiment of the mechanical pulling device 51A illustrated in FIG. 4, this is a rigid mechanical pulling device 51A which, in the present example, is provided to rotate the end piece 13A of the endoscope 5 with the endoscope objective 53 through an angle θ. As FIG. 4 shows, the rotation about the axis of the rigid endoscope 5 through the angle θ is effected by the actuating motor 47A, as part of the actuating device 67A. In this way, the field of view 65 of the endoscope 5 with a rigid, interchangeable end piece 13A can be rotated, so that the viewing angle can substantially be varied by adjusting the rotational angle θ.

In a similar way, the actuating apparatus 67A can also be used to tilt the rigid endoscope 5. Given the aforementioned tilt by a tilting angle θ, the viewing angle of the endoscope is likewise varied.

FIG. 5 shows, by way of example, a beneficial embodiment of the endoscope 5 having the flexible, interchangeable end piece 13B for the inspection of the fuel element 3. A suitable actuating device 67B for the flexible end piece 13B is likewise shown. In this case, the flexible end piece 13B is surrounded by a flexible hose 71. This is preferably an intrinsically flexible PVC hose 71 or a metallic corrugated hose 71. Furthermore, the endoscope 5 is closed off in a watertight manner by the hose 71.

In this embodiment, the flexible end piece 13B carries at the front end 49 the front optical opening 59. Through the optical opening 59, the light led to the front end emerges, and the image produced by the endoscope 5 is picked up. The field of view 65 of the endoscope 5 with the flexible end piece 13B therefore leads away from the front end of the endoscope. Disposed behind the front optical opening 59 of the endoscope 5 is the endoscope objective 53, which is illustrated schematically here by a lens. This is followed by the bundle of individual glass fibers 57, which are used for light guidance and image guidance. Also, guided in the intrinsically flexible hose 71 of the end piece 13B of the endoscope 5, in addition to the glass fiber bundle 57, is the intrinsically flexible mechanical pulling device 51B, which is fixed to the endoscope objective 53. As opposed to the rigid mechanical pulling device 51A, as illustrated in FIG. 4, the flexible pulling device 51B is used to bend at least the end piece 13B of the endoscope 5. It is therefore connected to the endoscope objective 53 at four points 56 to bend the end piece 13B on all sides. The fixing points 56 are each located at one end of two Cartesian axes oriented at right angles to one another on the endoscope objective 53. In a way similar to that shown in FIG. 4, the flange 19 is also used in FIG. 5 to couple the endoscope 5 with the flexible end piece 13B to the watertight, radiation-proof housing 7 or to interchange the endoscope 5 with the intrinsically flexible end piece 13B. In addition, the flange 19 shown in FIG. 5 has suitable lead throughs 58 for coupling the glass fiber bundle 57 and the flexible mechanical pulling device 51B to the devices inside the housing 7.

The advantageous configuration of the actuating device 67B for the endoscope 5 with the flexible end piece 13B is likewise illustrated schematically in FIG. 5. In this case, the actuating device 67B contains the flexible, mechanical pulling device 51B to bend the end piece 13B on all sides. The mechanical pulling device 51B in this configuration contains four pull cords, preferably made of metal, of which in each case one pair is set by the actuating motor 47B. Alternatively, configurations with two pull cords are also provided. The two cables of a pair are fixed to opposite sides of the endoscope objective 53, in each case on one of the axes disposed in Cartesian fashion in relation to each other. If the cables of a pair are each adjusted by one of the two actuating motors 47B by a distance Sᵥ and by a distance Sₕ with respect to each other, this has the effect of tilting the objective about a horizontal or vertical axis, and this accordingly effects the bending of the end piece 13B of the endoscope 5.

A further advantageous configuration of the inspection apparatus 1 for fuel elements is shown in FIG. 6. The sketch shows the cross section of the intrinsically flexible end piece 13B and, in schematic terms, the parts of an image production device 81 and of an illumination device 83. The cross section of the end piece 13B of the endoscope shows the intrinsically flexible endoscope sheath 71 and the cables 51B, the light guides 55A and the image conductors 55B disposed along the endoscope axis, in section. Differing from the embodiments of the inspection apparatus previously shown, in particular of the endoscope 5, an embodiment is illustrated here which, to bend the end piece of the endoscope on all sides, contains three cables 51B and in which three separate glass fiber bundles serve as a light guide 55A separate from the image conductor 55B. The light guides 55A are routed within the endoscope sheath 71 through the flange 19 (not shown here) as far as the light source 45 inside the container 7. Accordingly, the image conductor 55B is also routed to the image-receiving device 43, likewise inside the housing 7. The image receiving apparatus 43 is used to record an image 79 transmitted by the image guide 55B. Likewise illustrated schematically in FIG. 6 is an eyepiece 77, which is disposed between the image guide 55B and image receiving device 43 and whose lens system is indicated schematically here by two lenses. Depending on the application, the eyepiece can advantageously be interchanged with a different eyepiece in order to optimize the field of view 65, for example as regards the depth of focus or the focus.

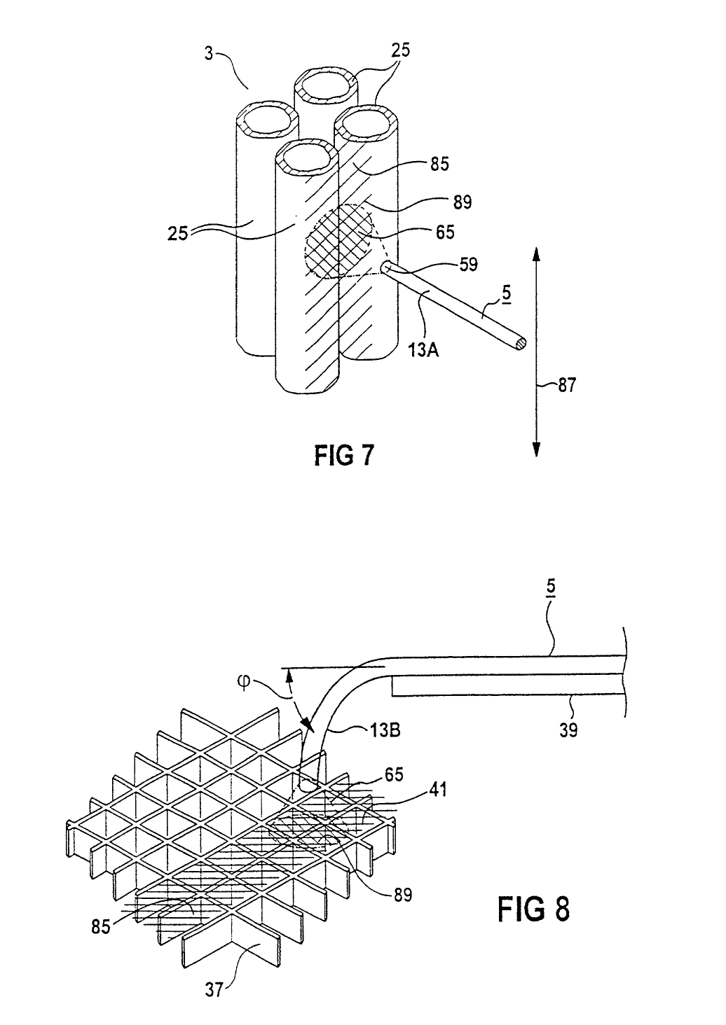

FIG. 7 shows, in schematic form, an exemplary procedure in the case of a method for the inspection of a region of the fuel element 3, in this case the procedure for the inspection of the surface of fuel rods 25 inside the fuel element 3.

As already partly explained in FIG. 1 and FIG. 2, for this purpose, the endoscope 5 with the intrinsically flexible end piece 13A or 13B carrying the endoscope objective 53, together with the actuating device 67A or 67B, the illumination device 83 and the image production device 81 are brought up to the fuel element 3 under water. As shown in FIG. 7, this can also be the endoscope 5 with a rigid end piece 13A.

In a second method step, the end piece 13A is then guided up to a subregion 89 of the fuel element 3 in such a way that the subregion 89 comes into the field of view 65 of the endoscope 5. This situation is recorded in FIG. 7.

The subregion 89 and further subregions 85, which come into the field of view 65 of the endoscope 5 as a result of displacement of the end piece 13A of the endoscope 5 along a vertical position 87, using the position manipulator 11, are then inspected in a third method step, the field of view 65 being illuminated by the illumination device 83. FIG. 7 illustrates the rigid endoscope 5 with the optical aperture 59 at the front end. However, it is also possible for example for the rigid endoscope 5 with the lateral optical aperture 75, as in FIG. 4, to be used. In this case, as a result of rotation of the end piece 13A of the rigid endoscope 5, the viewing angle can be changed, which substantially predefines the direction of the field of view 65, and thus the further subregions 85 of the fuel element can be inspected.

In FIG. 8, a further beneficial alternative to the aforementioned third method step is shown schematically. In a similar way to the procedure explained previously, here the aforementioned third method step with the endoscope 5 with the intrinsically flexible end piece 13B is sketched. Shown here is the inspection of the bottom piece cell 41 of the bottom piece 37, which is not accessible to an inspection with the rigid endoscope 5. However, since the endoscope 5 with the flexible end piece 13B is used here, the barely accessible subregion 89 of the bottom piece is moved into the field of view 65 of the endoscope 5 by bending the end piece 13B of the endoscope through an angle φ. The further subregions 85 are subsequently moved into the field of view 65 of the endoscope 5, and inspected, by curving and bending the end piece 13B of the endoscope 5 by further bending angles φ. In this case, the field of view 65 is illuminated by the illumination device 83, not illustrated here.

I claim:

1. An apparatus for inspecting a region of a fuel element including a spacer and a bottom piece in a nuclear reactor, comprising:
an image production device having an electronic image receiving device;
an endoscope having an intrinsically flexible end piece with an endoscope objective carried by said intrinsically flexible end piece;
a light guide for images optically connecting said endoscope objective to said electronic image receiving device;
an actuating device having an actuating motor for bending at least said intrinsically flexible end piece; and
an illumination device having a light source sending light to be discharged from said intrinsically flexible end piece.

2. The apparatus according to claim 1, wherein said intrinsically flexible end piece is interchangeable.

3. The apparatus according to claim 1, including a watertight container housing said electronic image receiving device, said light source and said actuating motor, said watertight container protecting housed components against radioactive radiation.

4. The apparatus according to claim 1, wherein said intrinsically flexible end piece is intrinsically flexible over a length of at least 10 millimeters.

5. The apparatus according to claim 1, wherein said intrinsically flexible end piece is suitable to be bent with a radius of curvature greater than 10 millimeters.

6. The apparatus according to claim 1, wherein said intrinsically flexible end piece is flexible in two directions.

7. The apparatus according to claim 1, wherein said actuating device is provided to move and rotate at least said intrinsically flexible end piece.

8. The apparatus according to claim 1, wherein said actuating device has a mechanical pulling device fixed to said endoscope objective, and said actuating motor actuates said mechanical pulling device for moving said endoscope objective.

9. The apparatus according to claim 1, wherein said endoscope includes a center portion and including a rigid part for guiding said center portion.

10. The apparatus according claim 1, wherein said electronic image receiving device is an electronic camera.

11. The apparatus according to claim 10, wherein said endoscope has an objective end with a front optical opening formed therein at said objective end.

12. The apparatus according to claim 1, wherein said light guide for said image production device contains a number of individual fibers.

13. The apparatus according to claim 12, including a further light guide connecting said illumination device to said endoscope, said light guide and said further light guide being separate from each other.

14. The apparatus according to claim 1, wherein said illumination device is configured for a discharge of virtually white light including light similar to daylight.

15. The apparatus according to claim 3, including a flange for securing said intrinsically flexible end piece to said watertight container allowing said intrinsically flexible end piece to be interchanged.

16. The apparatus according to claim 1, including a flange coupling said endoscope to said image production device, to said illumination device and to said actuating motor.

17. The apparatus according to claim 1, wherein said endoscope, said image production device, said illumination device and said actuating device are resistant to radioactive radiation.

18. The apparatus according to claim 1, wherein said endoscope is watertight.

19. The apparatus according to claim 3, including a shield disposed in said watertight container for protecting said image-receiving device and said illumination device against radioactive radiation.

20. The apparatus according to claim 19, wherein said watertight container and said shield protect against radioactive radiation, at least up to a distance of 0.5 meters from the fuel element.

21. The apparatus according to claim 1, wherein said image production device, said actuating device and said illumination device all have electrical parts that are protected against water at a water depth of more than 10 meters.

22. The apparatus according to claim 1, including a mounting frame for carrying at least said image production device, said actuating device and said illumination device.

23. The apparatus according to claim 1, including an image recording and displaying device for reproducing the images produced by said image production device.

24. The apparatus according to claim 1, including:
a control device for remote control of said endoscope; and
an electrical power supply device for feeding power to said light source, said image production device, and said actuating motor.

25. The apparatus according to claim 1, wherein said intrinsically flexible end piece is intrinsically flexible over a length of at least 50 millimeters.

26. The apparatus according to claim 1, wherein said intrinsically flexible end piece is flexible in all directions.

27. An inspection method which comprises the steps of:
using an intrinsically flexible optical endoscope for a surface inspection of a region of a fuel element disposed under water in a nuclear reactor.

28. A method for inspecting a region of a fuel element disposed under water in a nuclear reactor, including a surface of a fuel rod, barely accessible regions of a bottom piece and of a spacer of the fuel element, which comprises the steps of:
providing an inspection device formed of an endoscope having an intrinsically flexible, easily interchangeable end piece carrying an endoscope objective, an actuating device, an illumination device and an image production device, the actuating device, the illumination device and the image production device being accommodated in a watertight manner in a common container for protecting against radioactive radiation in such a way that they remain virtually undamaged over a plurality of inspection operations;
bringing the inspection device up to the fuel element under water;
leading the end piece up to a subregion of the fuel element in such a way that the subregion comes into a field of view of the endoscope;
inspecting the subregion and further subregions, which come into the field of view of the endoscope as a result of displacement of the endoscope and curvature of the end piece; and
illuminating the field of view using the illumination device, so that in this way the inspection of the fuel element is performed virtually completely and the end piece of the endoscope is interchanged virtually regularly, advantageously after about an hour in each case.
